(19) United States
(12) Patent Application Publication
(10) Pub. No.: US 2025/0088327 A1
(43) Pub. Date: Mar. 13, 2025

(54) PREDICTION BASED UCI MULTIPLEXING PRIORITY

(71) Applicant: QUALCOMM Incorporated, San Diego, CA (US)

(72) Inventors: Tianyang BAI, Mountain View, CA (US); Hua WANG, Basking Ridge, NJ (US); Junyi LI, Fairless Hills, PA (US)

(21) Appl. No.: 18/465,921

(22) Filed: Sep. 12, 2023

(51) Int. Cl. H04L 5/00; H04B 7/06; H04W 72/21; H04W 72/566

(52) U.S. Cl. CPC H04L 5/0051; H04B 7/0626; H04W 72/21; H04W 72/566

(57) ABSTRACT

Prediction based UCI multiplexing priority is described. An apparatus is configured to generate, based on an ML model and a measurement(s) for a first set of RS metrics of a RS, a prediction for a second set of RS metrics of the RS, and to provide an indication of the prediction based on a priority condition for the prediction to a network node. Another apparatus is configured to receive a measurement indication of a measurement(s) for a first set of RS metrics of a RS, wherein the first set of RS metrics associated with a priority condition for a prediction. The apparatus is configured to generate, based on an ML model, the priority condition for the prediction, and/or the measurement indication of the at least one measurement, the prediction for a second set of RS metrics of the RS, and to provide an indication of the prediction to a UE.

### TECHNICAL FIELD

The present disclosure relates generally to communication systems, and more particularly, to wireless communications utilizing reference signal reporting and beam forming.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a user equipment (UE) or a portion thereof. The apparatus is configured to generate, based on a machine learning (ML) model and at least one measurement for a first set of reference signal metrics of a reference signal, a prediction for a second set of reference signal metrics of the reference signal. The apparatus is also configured to provide, for a network node, an indication of the prediction for the second set of reference signal metrics of the reference signal based on a priority condition associated with the prediction.

In the aspects, the method includes generating, based on an ML model and at least one measurement for a first set of reference signal metrics of a reference signal, a prediction for a second set of reference signal metrics of the reference signal. The method also includes providing, for a network node, an indication of the prediction for the second set of reference signal metrics of the reference signal based on a priority condition associated with the prediction.

In another aspect of the disclosure, a method, a computer-readable medium, and an apparatus are provided. The apparatus may be a network node or a portion thereof. The apparatus is configured to receive, from a UE, a measurement indication of at least one measurement for a first set of reference signal metrics of a reference signal, where the first set of reference signal metrics of the reference signal is associated with a priority condition associated with a prediction. The apparatus is also configured to generate, based on at least one of an ML model, the priority condition associated with the prediction, or the measurement indication of the at least one measurement for the first set of reference signal metrics of the reference signal, the prediction for a second set of reference signal metrics of the reference signal. The apparatus is also configured to provide, for the UE, an indication of the prediction for the second set of reference signal metrics of the reference signal.

In the aspects, the method includes receiving, from a UE, a measurement indication of at least one measurement for a first set of reference signal metrics of a reference signal, where the first set of reference signal metrics of the reference signal is associated with a priority condition associated with a prediction. The method also includes generating, based on at least one of an ML model, the priority condition associated with the prediction, or the measurement indication of the at least one measurement for the first set of reference signal metrics of the reference signal, the prediction for a second set of reference signal metrics of the reference signal. The method also includes providing, for the UE, an indication of the prediction for the second set of reference signal metrics of the reference signal.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a neural network (NN) model and beam prediction.

FIG. 5 is a diagram illustrating examples of ML model implementations and a beam report configuration.

FIG. 6 is a call flow diagram for wireless communications, in accordance with various aspects of the present disclosure.

FIG. 7 is a diagram illustrating examples of prediction indications and priority conditions, in accordance with various aspects of the present disclosure.

FIG. 8 is a call flow diagram for wireless communications, in accordance with various aspects of the present disclosure.

FIG. 9 is a diagram illustrating examples of measurement indications and priority conditions, in accordance with various aspects of the present disclosure.

FIG. 10 is a flowchart of a method of wireless communication, in accordance with various aspects of the present disclosure.

FIG. 11 is a flowchart of a method of wireless communication, in accordance with various aspects of the present disclosure.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

Wireless communication networks, such as a 5G NR network, among other examples of wireless communication networks, may be designed to support communications between network nodes (e.g., base stations, gNBs, etc.) and UEs. In such communications, beam forming and management may be utilized to improve performance through beam prediction in time and/or spatial domains for overhead/latency reduction, as well as improvements in beam selection accuracy. In some cases, AI/ML may be utilized to predict beams, and may involve indications of capabilities, configuration procedures (e.g., training/inference), validation/testing procedures, and management of data and/or AI/ML models. These modes may be NN models with standardized inputs and outputs for each NN function (NNF), including inter-vendor information elements (IEs) and optional IEs for flexible implementations.

However, some configurations for uplink control information (UCI) reporting and priority conditions may be insufficient for ML based beam prediction procedures. For example, ML based beam predictions may benefit from information such as prediction time, an ML model identifier (ID), confidence level, and/or the like, along with associated priorities, which are not provided in current implementations. Additionally, while channel state information (CSI) may be provided to a network node from a UE to indicate reference signal (RS) measurements associated with beam configurations, such reporting may be based on priorities that do not sufficiently account for time series measurements in UE-side ML model implementations. Further, there is a lack of multiplexing priority conditions for UE-side ML modeling.

Various aspects relate generally to reference signal reporting and beam forming. Some aspects more specifically relate to prediction based UCI multiplexing priority. In some examples, various types of reports are provided for ML based beam prediction. For instance, in base station implementations for beam prediction, a UE may report a time series of measured RSRPs or RSRP values, while in UE implementations for beam prediction, a UE may report predicted RSRPs or RSRP values. The reports according to aspects herein may be reported to a base station as UCI, and multiplexing conditions/rules may be provided for the described UCI types to support beam prediction. In some examples, CSI report priority conditions based on the nature of prediction related UCI are provided, extending prior reporting to account for prediction time, ML model ID, confidence level, and/or the like. In various aspects, a prediction report that corresponds to later time may be skipped first, different ML models/ML functions may have different priorities, and reports with low confidence/high error level may be skipped first (e.g., low confidence/high error level may be derived based on a history performance monitoring procedure such as when certain prediction functions on average have a lower/higher RSRP prediction error.

Particular aspects of the subject matter described in this disclosure can be implemented to realize one or more of the following potential advantages. In some examples, by providing implementations for beam prediction at network nodes and at UEs with varied UE reporting according to the specific implementations, the described techniques can be used to flexibly predict beams by a UE or by the network. In some examples, by providing multiplexing conditions/rules in reporting for beam prediction, the described techniques can be used to efficiently use available bandwidth. In some examples, by providing priority conditions/rules in reporting for beam prediction, the described techniques can be used to efficiently use available bandwidth while also utilizing more desirable data as inputs for ML beam prediction models.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

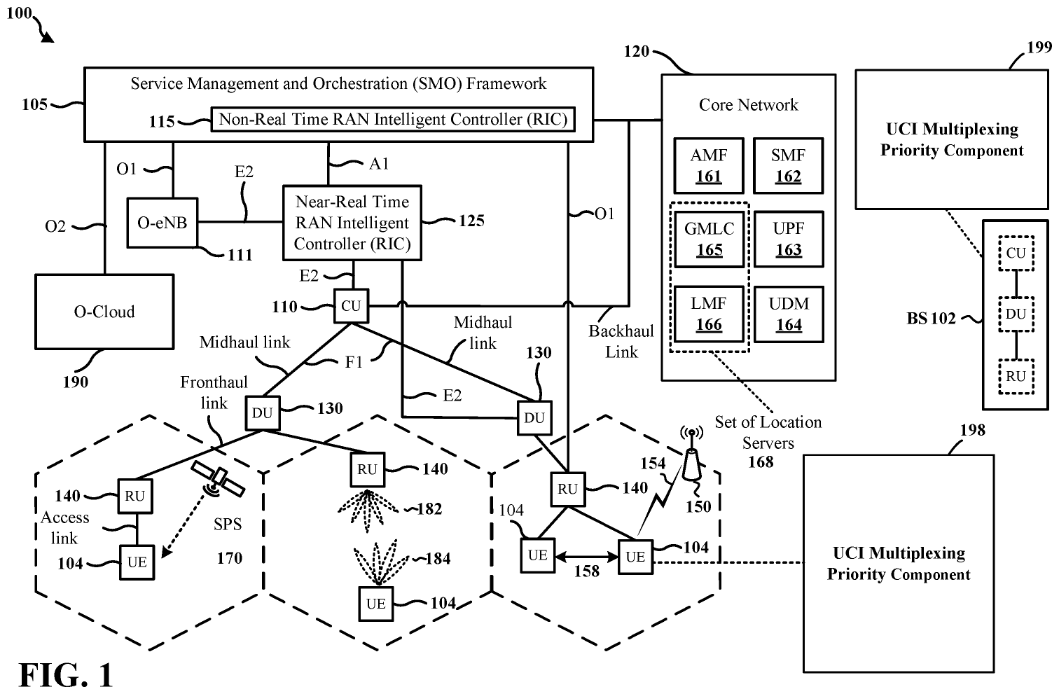

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHZ (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHZ-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, cNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a UCI multiplexing priority component 198 (“component 198”) that may be configured to generate, based on a machine learning (ML) model and at least one measurement for a first set of reference signal metrics of a reference signal, a prediction for a second set of reference signal metrics of the reference signal. The component 198 may also be configured to provide, for a network node, an indication of the prediction for the second set of reference signal metrics of the reference signal based on a priority condition associated with the prediction. The component 198 may be configured to communicate via at least one beam based on the indication of the prediction, where the indication of the prediction for the second set of reference signal metrics of the reference signal is associated with the at least one beam. The component 198 may be configured to receive, from the network node, an ML configuration indicative of the ML model. The component 198 may be configured to receive, from the network node and prior to the generation of the prediction, the reference signal. The component 198 may be configured to perform the at least one measurement for the first set of reference signal metrics of the reference signal. In certain aspects, the base station 102 may have a UCI multiplexing priority component 199 (“component 199”) that may be configured to receive, from a UE, a measurement indication of at least one measurement for a first set of reference signal metrics of a reference signal, where the first set of reference signal metrics of the reference signal is associated with a priority condition associated with a prediction. The component 199 may also be configured to generate, based on at least one of an ML model, the priority condition associated with the prediction, or the measurement indication of the at least one measurement for the first set of reference signal metrics of the reference signal, the prediction for a second set of reference signal metrics of the reference signal. The component 199 may also be configured to provide, for the UE, an indication of the prediction for the second set of reference signal metrics of the reference signal. The component 199 may be configured to communicate via at least one beam based on at least one of the prediction or the indication of the prediction, where the indication of the prediction for the second set of reference signal metrics of the reference signal is associated with the at least one beam. The component 199 may be configured to configure the UE with the priority condition associated with the prediction. The component 199 may be configured to provide, to the UE and prior to the generation of the prediction, the reference signal. Accordingly, aspects herein for prediction based UCI multiplexing priority provide multiplexing and priority conditions by which measured and predicted reference signal metrics are indicated to network nodes and UEs to support accurate and efficient beam predictions/inferences.

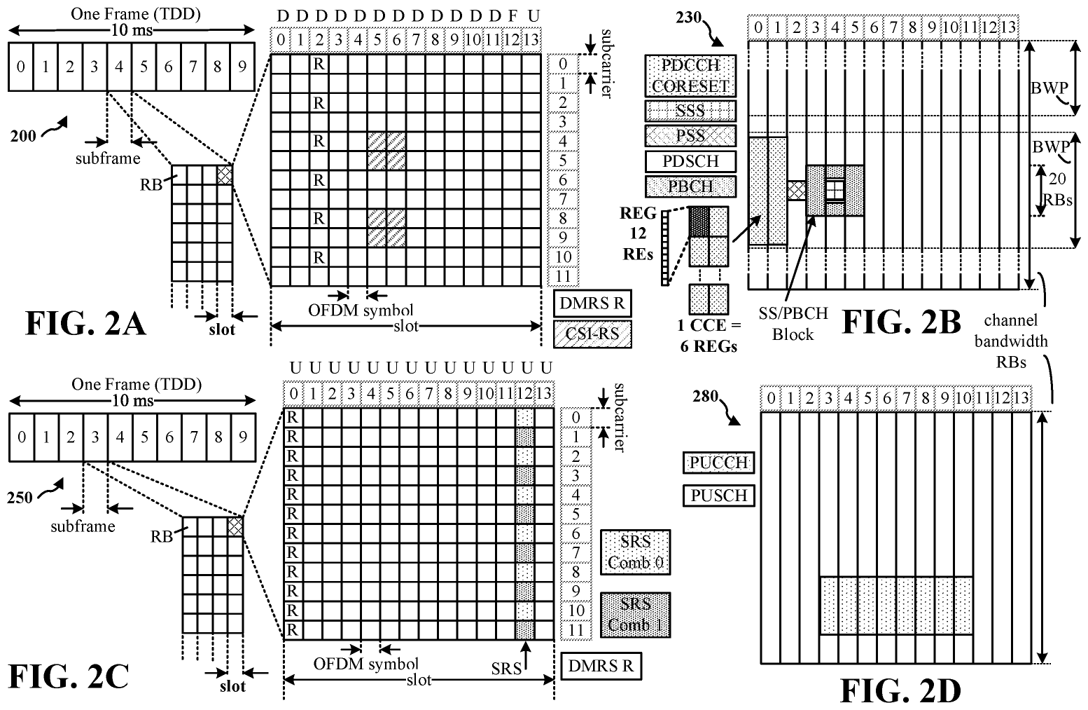

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A. 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δƒ = 2^{μ} · 15 [KHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

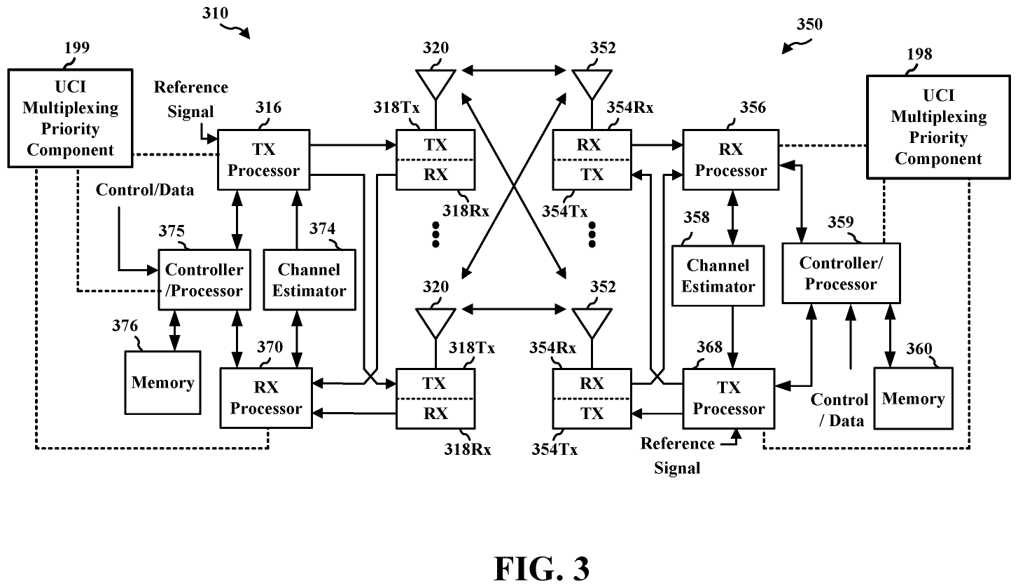

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

Wireless communication networks that support communications between network nodes and UEs may utilize beam forming and management to improve performance through beam prediction in time and/or spatial domains for overhead/latency reduction, as well as improvements in beam selection accuracy. In some cases, AI/ML may be utilized to predict beams, and may involve indications of capabilities, configuration procedures (e.g., training/inference), validation/testing procedures, and management of data and/or AI/ML models. These modes may be NN models with standardized inputs and outputs for each NNF, including inter-vendor IEs and optional IEs for flexible implementations. However, some configurations for UCI reporting and priority conditions may be insufficient for ML based beam prediction procedures. For example, ML based beam predictions may benefit from information such as prediction time, an ML model ID, confidence level, and/or the like, along with associated priorities, which are not provided in current implementations. Additionally, while CSI may be provided to a network node from a UE to indicate RS measurements associated with beam configurations, such reporting may be based on priorities that do not sufficiently account for time series measurements in UE-side ML model implementations. Further, there is a lack of multiplexing priority conditions for UE-side ML modeling.

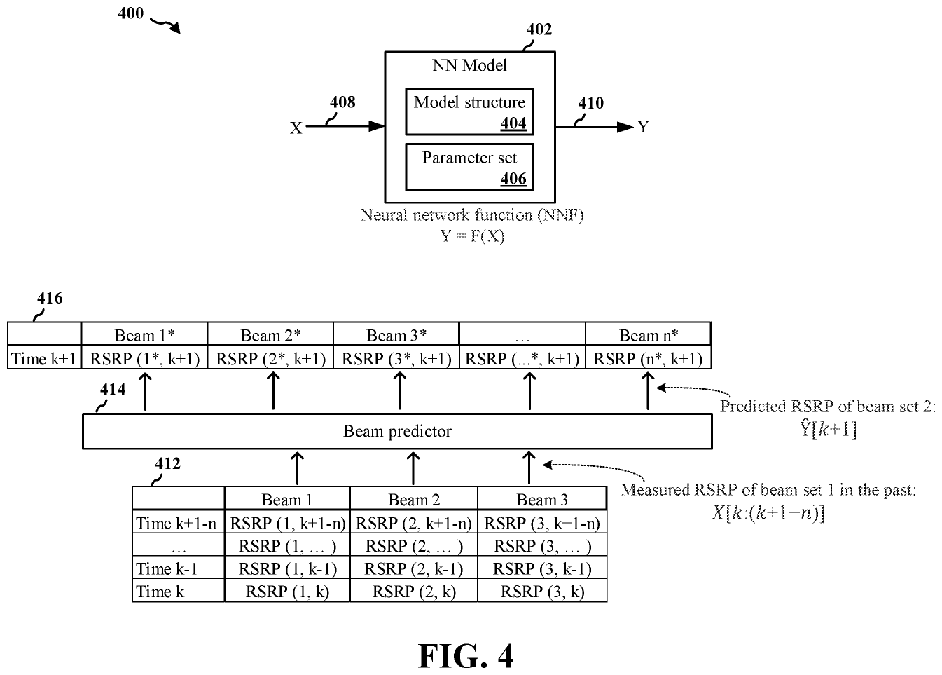

FIG. 4 is a diagram 400 illustrating an example of a NN model and beam prediction. Diagram 400 is described in the context of a NN model 402 that implements a NNF shown as Y=F(X). The NNF (e.g., Y=F(X)) is a function to be supported by the NN model 402. Each NNF may be identified by a standardized NNF ID, although non-standardized IDs of NNFs for private extensions may also be implemented.

The NN model 402 is shown as including an input X 408 and an output Y 410, which may be standardized. The input X 408, which may be standardized, and the output Y 410 may be for each NNF associated with the NN model 402. In some implementations, IEs for inter-vendor interworking may be standardized and/or called for, while optional IEs for flexible implementation may also be utilized. In some examples, one NNF may be supported by multiple models, e.g., in vendor specific implementations.

The NN model 402 may be defined as a model structure with a parameter set, and may be defined by the operator thereof, an infra vendor, or a third party (e.g., an OEM). As shown, the NN model 402 may include a model structure 404 and a parameter set 406. The model structure 404 may be identified by a model ID (e.g., that includes a default parameter set). The model ID may be unique in the wireless network, and each model ID may be associated with an NNF. The parameter set 406 may include weights of the NN model 402 and other configuration parameters, and may be location and/or configuration specific.

An example of beam prediction by a beam predictor 414 is also illustrated in diagram 400. In some configurations, the beam predictor 414 may be associated with the NN model 402. Generally, an algorithm may be trained to predict a future RSRP of a beam set. As shown, a beam set 2 (e.g., a second beam set 416 with a predicted RSRP of Ý [k+1]) may be predicted by the beam predictor 414 based on past measurement of a beam set 1 (e.g., a first beam set 412 with a measured RSRP in the past of X[k:(k+1−n)]). In some examples, the algorithm of the beam predictor 414 may be a recursive NN model or a traditional algorithm, and the algorithm may be trained and/or maintained by a network node, e.g., a gNB. In some examples, the algorithm may be run by the network node gNB and/or run by a UE. If run by the UE, the network node may configure the algorithm for the beam predictor 414 at the UE. The beam set 2 (e.g., the second beam set 416) may be the same as or similar to the beam set 1 (e.g., the first beam set 412), or may be substantially different. In one case, the beam predictor 414 may measure (e.g., a subset of) SSBs to predict all SSBs in the future, or may measure SSBs to predict some refined CSI-RS beams, e.g., for unicast PDSCH/PDCCH. In an alternative example, an output may be a best beam ID at a future time or other related metric at the future time. Such implementations may save RS overhead, may save UL feedback, and/or may save UE power. For RS overhead, in one example, sending a RS to track beam/channel frequently may be obviated; for UL feedback, a UE may skip a feedback channel estimation as frequently, and for UE power, a UE may skip measurements and feedback as frequently as may otherwise be performed.

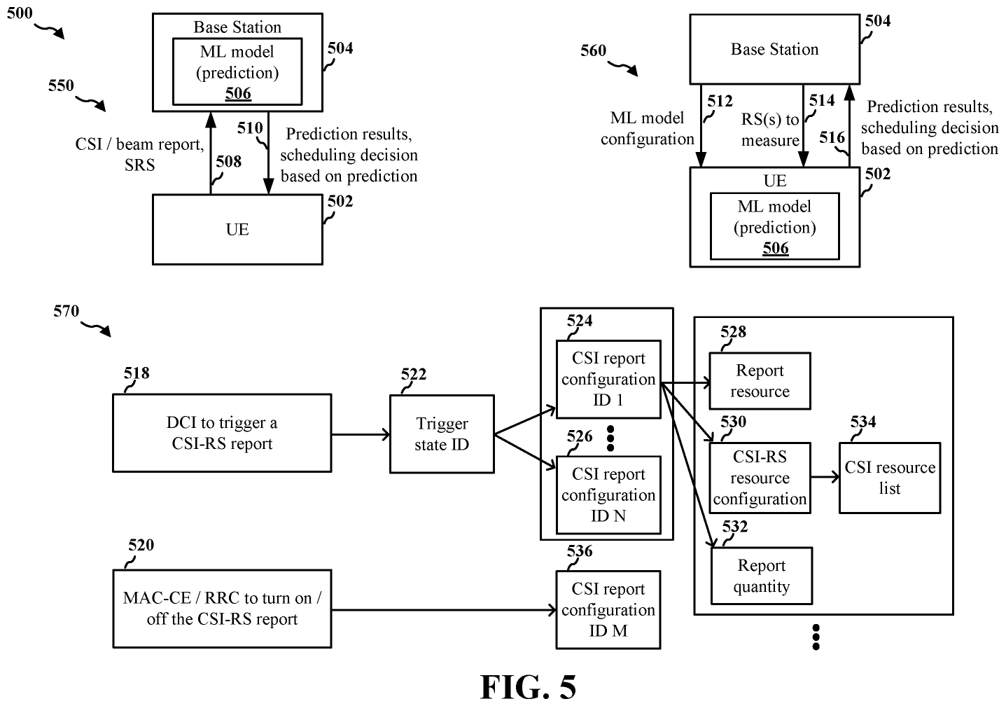

FIG. 5 is a diagram 500 illustrating examples of ML model implementations and a beam report configuration. Diagram 500 shows a configuration 550, a configuration 560, and a configuration 570. Diagram 500 is illustrated in the context of a UE 502 and a base station 504 (e.g., a gNB and/or the like).

In the configuration 550, an ML model 506 (also “an ML module”) for prediction of beams may be run at the base station 504. The UE 502 may provide to the base station 504 feedback CSI/a beam report 508, and may also optionally provide an SRS therewith. The base station 504 may be configured to run the ML model 506 based on the feedback CSI/a beam report 508 from the UE 502. The base station 504 may provide to the UE 502 prediction results 510, which may include a scheduling decision(s) based on the prediction from the ML model 506. Such a use case may be implemented for power/computation power limited UEs.

In the configuration 560, the ML model 506 for prediction of beams may be run at the UE 502. In such a configuration, the ML model 506 at the UE 502 may be configured by the base station 504 with an ML model configuration 512. The UE 502 may be configured to run the ML model 506 based on local measurements, in addition to signaling received from the base station 504, e.g., a RS(s) 514 to be measured by the UE 502. The UE 502 may report prediction results 516, based on configuration/triggering conditions, which may include a scheduling decision based on the prediction. Such a use case may advantageously be performed at the UE 502 as the UE side may typically have more measurement results than network side, and may benefit from less overhead for reporting than in the configuration 550. In contrast, such an implementation may involve higher computation capability at the UE 502 than in the configuration 550.

The configuration 570 illustrates beam reporting. In some examples, a CSI report/RS may be periodic, semi-persistent, or aperiodic, and the report quantity may be, for example, L1-RSRP. SINR, etc. A UE may be configured (e.g., by a network node) with a list of multiple CSI-RS/SSB to measure, and may report a subset of (e.g., up to 4) L1-RSRP of a CSI-RS/SSB in a report. Which CSI-RS/SSB from the configured list is chosen to be included in the report may be based on UE implementation, e.g., the strongest or top four beams may be reported. In one example, a CSI-RS/SSB ID may be included in the report to indicate whose RSRP is reported. In some examples, a differential report may be used in L1-RSRP beam reporting. For instance, a 7-bit field may be used for an absolute report of the largest RSRP(s), and a 4-bit field may be used for the differential report for the remaining RSRP(s). A raw RSRP may be quantized in the report based on implementations (e.g., a 2 dB quantization step for L1-RSRP).

In the context of the UE 502 and the base station 504, and as shown in the configuration 570, the base station 504 may provide to the UE 502 DCI 518 to trigger a CSI-RS report, and may provide to the UE 502 a MAC control element (MAC-CE)/RRC 520 to turn on/off the CSI-RS report. Associated with the DCI 518 may be a trigger state ID 522 that is in turn associated with a number (e.g., 1 to N) CSI report configuration IDs: a CSI report configuration ID 1 524, . . . , a CSI report configuration ID N 526. Each of the CSI report configuration IDs (e.g., as shown for the CSI report configuration ID 1 524) may be associated with a report resource 528, a CSI-RS resource configuration 530, and a report quantity 532, and the CSI-RS resource configuration 530 may be associated with a CSI resource list 534. The MAC-CE/RRC 520 may be associated with a CSI report configuration ID M 536, as shown.

Additionally, there are three types of UCI multiplexing conditions currently utilized in wireless networks. First. UCI multiplexing conditions may be based on a PHY priority index associated with each UCI, and then, within the same PHY priority index, a priority condition/rule are applied in the following order: ACK/NACK>scheduling request (SR)>CSI Part 1>CSI Part 2. The priority conditions defined for different CSI reports within the CSI UCI type are: if two CSI reports overlap in time, the CSI report with a higher score will be skipped. For example, current CSI reports are associated with a CSI priority value Pri_{iCSi} (y, k, c, s):

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s ,$$

y=0 for aperiodicity, y=1 for semi-persistency on PUSCH, y=2 for semi-persistency on PUCCH, y=3 for periodicity on PUCCH, k=0 if L1 RSRP/SINR is sent, k=1 if no L1 RSRP/SINR is sent, c is serving cell index/ID, N_{cells} is the value of the higher layer parameter maxNrofServingCells, s is the parameter reportConfigID, and Mₛ is the value of the higher layer parameter maxNrofCSI-ReportConfigurations.

Aspects herein enable extensions and alternatives of the above. For instance, aspects provide for new CSI report priority conditions/rules based on the properties of the predicted beam report. Specifically, the aspects provide extensions to UCI rules for beam management reports (e.g., based on their priority, timing, and/or the like).

Aspects herein for prediction based UCI multiplexing priority provide for various types of reports for ML based beam prediction. For instance, in base station implementations for beam prediction, a UE may report a time series of measured RSRPs or RSRP values, while in UE implementations for beam prediction, a UE may report predicted RSRPs or RSRP values. The reports according to aspects herein may be reported to a base station as UCI, and multiplexing conditions/rules may be provided for the described UCI types to support beam prediction. In some examples, CSI report priority conditions based on the nature of prediction related UCI are provided, extending prior reporting to account for prediction time, ML model ID, confidence level, and/or the like. In various aspects, a prediction report that corresponds to later time may be skipped first, different ML models/ML functions may have different priorities, and reports with low confidence/high error level may be skipped first (e.g., low confidence/high error level may be derived based on a history performance monitoring procedure such as when certain prediction functions on average have a lower/higher RSRP prediction error. Beams may be flexibly predicted by a UE or by the network by providing implementations for beam prediction at network nodes and at UEs with varied UE reporting according to the specific implementations. Available bandwidth may be efficiently used by providing multiplexing conditions/rules in reporting for beam prediction. Available bandwidth may also be efficiently used while also utilizing more desirable data as inputs for ML beam prediction models by providing priority conditions/rules in reporting for beam prediction.

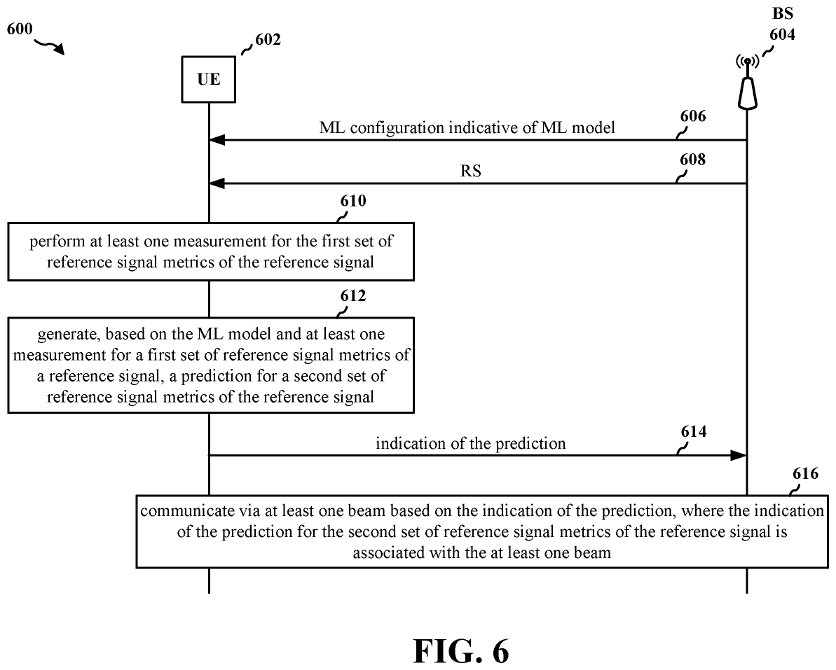

FIG. 6 is a call flow diagram 600 for wireless communications, in various aspects. Call flow diagram 600 illustrates prediction based UCI multiplexing priority for a wireless device (a UE 602, by way of example) that communicates with a network node (a base station 604, such as a gNB or other type of base station, by way of example, as shown), in various aspects. Aspects described for the base station 604 may be performed by the base station in aggregated form and/or by one or more components of the base station in disaggregated form. Additionally, or alternatively, the aspects may be performed by the UE 602 autonomously, in addition to, and/or in lieu of, operations of the base station 604.

In the illustrated aspect, the UE 602 may be configured to run or execute an ML model for the prediction of beams, e.g., via inference. The UE 602 may be configured to receive, and the base station 604 may be configured to transmit/provide, a ML configuration 606 that is indicative of the ML model (also ML module/function) to be executed by the UE 602. In aspects, different ML models may be configured for the UE 602 by the ML configuration 606, e.g., for different metric types such as SINR, RSRP, etc., for different beams and/or cells, for different prediction time ranges such a next slot, a next 10 slot average, etc. Different prediction modules/outputs of the ML configuration 606 may have different confidence levels, which may be indicated by a value of the previous average errors. The ML configuration 606 and the indicated ML model may also be associated with a priority condition(s) that may be indicative of/a basis for how multiplexing and reporting is performed for the above-mentioned parameters and by which the UE 602 determines reference signal metric predictions/measurements to be provided for the base station 604. The UE 602 may also be configured to receive, from the base station 604 and prior to the generation (at 612) of the prediction (e.g., for a beam(s)), a reference signal (RS) 608. In aspects, the RS 608 may refer generally to one or more CSI-RSs, SSBs, and/or the like.

The UE 602 may be configured to perform (at 610) at least one measurement for a first set of reference signal metrics of the RS 608. As used herein, reference signal metrics may be characteristics/parameters of reference signals derived from measurements thereof, e.g., power, signal-to-noise ratio (SNR) or signal strength, etc. In aspects, the first set of reference signal metrics for which a measurement(s) is performed (at 610) by the UE 602 may be and/or have a type of SINR, RSRP, etc., and may be referred to as measured/past reference signal metrics. The first set of reference signal metrics may include one or more values measured for the RS 608 at different times, the same time, etc. The UE 602 may be configured to generate (at 612), based on the ML model (e.g., as indicated in the ML configuration 606) and the at least one measurement for a first set of reference signal metrics of the RS 608 (e.g., as performed at 610), a prediction for a second set of reference signal metrics of the RS 608. As an example, the at least one measurement for a first set of reference signal metrics of the RS 608 may be an input for the ML model executed at the UE 602, and the prediction for the second set of reference signal metrics of the RS 608 that is generated (at 610) may be an output of the ML model. In aspects, the prediction for the second set of reference signal metrics of the RS 608 may correspond to a future time and/or future communications with the base station 604.

The UE 602 may be configured to transmit/provide, and the base station 604 may be configured to receive, an indication 614 of the prediction that is generated (at 612) by the UE 602. The predicted metric(s) (e.g., the second set of reference signal metrics of the RS 608) may be reported by the UE 602, as a portion of the indication 614 of the prediction, to the base station 604 via UCI. The indication 614 of the prediction for the second set of reference signal metrics of the RS 608 may be associated with at least one beam, in various aspects. The UE 602 and the base station 604 may be configured to communicate (at 616) at a future time via the at least one beam based on the indication 614 of the prediction. That is, a beam(s) associated with the indication 614 of the prediction that is transmitted/provided by the UE 602 and received by the base station 604 may be later utilized for the UE 602 and/or the base station 604 to communicate (at 616).

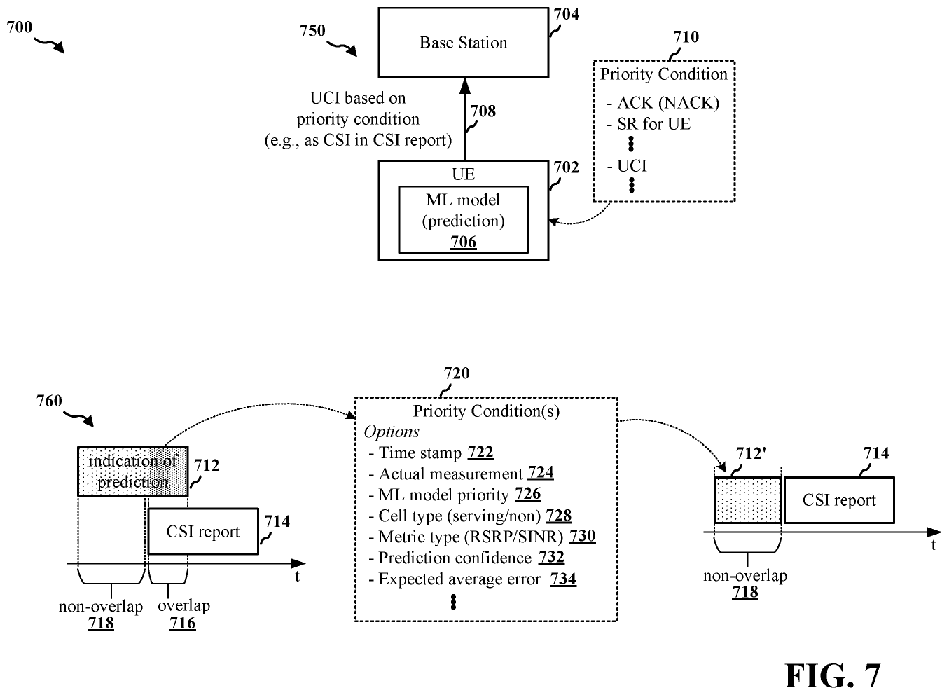

FIG. 7 is a diagram 700 illustrating examples of prediction indications and priority conditions, in various aspects. Diagram 700 shows a configuration 750 and a configuration 760 in the context of a UE 702 and a base station 704. Diagram 700 may be an aspect of call flow diagram 600 in FIG. 6, and the UE 702 and the base station 704 may be respective aspects of the UE 602 and the base station 604 in FIG. 6.

In the configuration 750, the UE 702 is shown as including an ML model 706, which may be utilized for inference/prediction of beams, as described herein. As noted above in the description of FIG. 6, predicted metric(s) (e.g., the second set of reference signal metrics of the RS 608) may be reported by the UE 602, as a portion of the indication 614 of the prediction, to the base station 604 via UCI. In the configuration 750, a predicted metric(s) (e.g., the second set of reference signal metrics of the RS 608) may be reported by the UE 702, as a portion of an indication 708 of the prediction, to the base station 704, via UCI based on a priority condition 710. The priority condition 710 may indicate the UCI has a first priority that is lower than at least one of a second priority of an ACK or ACK/NACK associated with the UE 702 or a third priority of a SR associated with the UE 702. Additionally, the UCI may be CSI included in a CSI report. In aspects, UCI carrying a predicted metric, e.g., as the indication 708 of the prediction, may be a new type of CSI report that utilizes multiplexing conditions/rules and/or priority conditions/rules, as described herein, to improve beam prediction.

Referring now to the configuration 760, an aspect for a priority condition 720 is shown. In the illustrated aspect, the priority condition 720 may be implemented by the UE 702 for multiplexing when providing indications of predictions in scenarios where an overlap in time exists with a provision of a CSI report. As one example, an indication 712 of a prediction is shown that overlaps in time with a CSI report 714. The overlapping may include a first portion of the indication 712 of the prediction with an overlap time 716 associated with the CSI report 714 and a second portion of the indication 712 of the prediction with a non-overlap time 718 associated with the CSI report 714. In order for the UE 702 to provide the CSI report 714 to the base station 704, as well as predicted metrics for the indication 712, multiplexing is provided, in aspects, based on the priority condition 720 for provision during the non-overlap time 718.

In various configurations, as described below, the priority condition 720 may include one or more options for identifying and/or selecting predicted metrics for the UE 702 to provide to the base station 704. In an example, the priority condition 720 may be based on a predicted time stamp 722 that corresponds to predicted metrics associated with the indication 712 of the prediction (e.g., a second set of reference signal metrics, described herein), where later values of the predicted time stamp 722 are associated with lower relative priorities compared to earlier values of the predicted time stamp 722. In an example, the priority condition 720 may be based on whether the prediction is associated with a measurement (e.g., an actual measurement 724) or with a prediction of the predicted metrics associated with the indication 712 of the prediction (e.g., a second set of reference signal metrics, described herein). In an example, the priority condition 720 may be based on an ML model priority 726 of the ML model, which may be standardized or may be configured by the base station 704. In an example, the priority condition 720 may be based on whether the prediction is associated with a cell type 728, such as serving cell measurement or a non-serving cell measurement. In an example, the priority condition 720 may be based on a reference signal metric type 730 associated with the predicted metrics (e.g., associated with the first set of reference signal metrics and/or the second set of reference signal metrics, described herein). In such aspects, the reference signal metric type 730 may be an RSRP, a signal-to-interference and noise ratio (SINR), and/or the like, where an RSRP type is given a higher priority than an SINR type or another interference type. In an example, the priority condition 720 may be based on a confidence level (e.g., a prediction confidence 732) and/or an expected average error 734 associated with the prediction. In such aspects, the prediction confidence 732 and/or an expected average error 734 associated with the prediction may be indicated by the network (e.g., by the base station 704).

Based on the option(s) applied for the priority condition 720, the UE 702 may be configured to transmit/provide, and the base station 704 may be configured to receive, the CSI report 714 as well as identified/selected predicted metrics of the indication 712, via multiplexing, as an indication 712′ of the prediction based on the priority condition 720 for provision during the non-overlap time 718. Accordingly, aspects provide for a revised or new priority metric (e.g., a CSI priority value) for CSI reporting.

For example, and according to aspects, a CSI priority value Pri_{iCSi} (y, k, c, s) is provided:

$${Pri}_{iCSI} ( y , k , c , s ) = ( 2 \cdot {N}_{cells} \cdot {M}_{s} \cdot y + {N}_{cells} \cdot {M}_{s} \cdot k + {M}_{s} \cdot c + s ) + z \cdot X - 2 * t + p ,$$

where y=0 for aperiodicity, y=1 for event triggered, y=2 semi-persistency on PUSCH, y=3 for semi-persistency on PUCCH, y=4 for periodicity on PUCCH, k=0 if L1 RSRP/SINR is sent, k=1 if no L1 RSRP/SINR is sent, c is the serving cell index/ID where the report configuration is configured, t is the predicted time stamp, p is the priority of the ML module (e.g., p=0 for high priority, p=1 for medium priority, p=2 for high priority), X is a predefined term to distinguish reports carrying serving and non-serving cell measurements (e.g., X may be 9 N_{cells}·Mₛ+Mₛ, which may be the maximum value the measurement based report can achieve), z=1 when the report configuration is not associated with any actual measurement, and z=0 when the report configuration is associated with actual measurement.

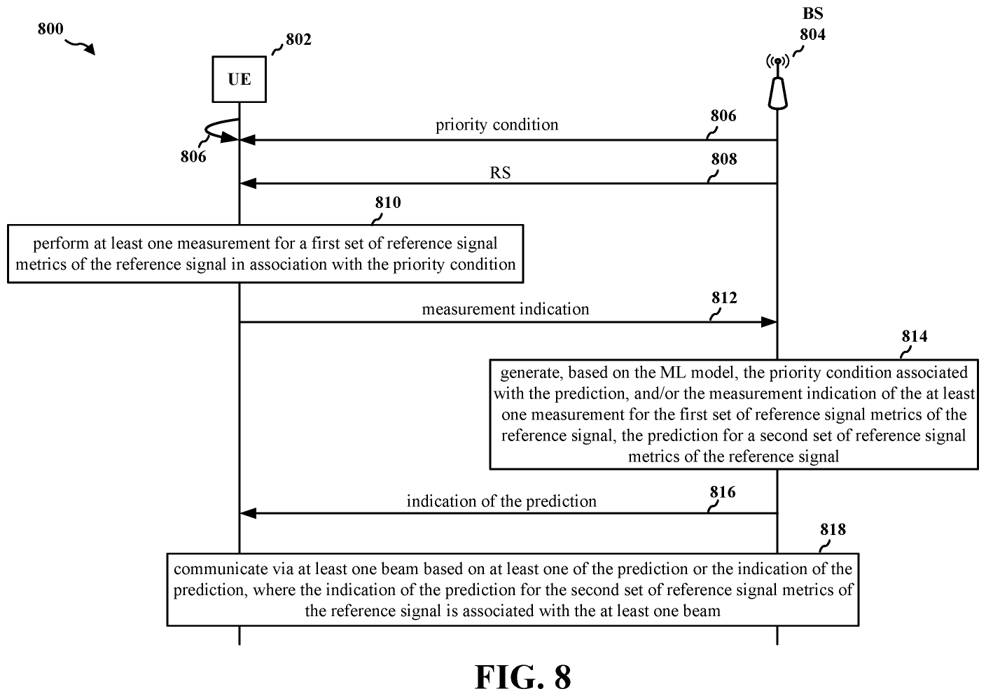

FIG. 8 is a call flow diagram 800 for wireless communications, in various aspects. Call flow diagram 800 illustrates prediction based UCI multiplexing priority for a network node (a base station 804, such as a gNB or other type of base station, by way of example, as shown) that communicates with a wireless device (a UE 802, by way of example), in various aspects. Aspects described for the base station 804 may be performed by the base station in aggregated form and/or by one or more components of the base station in disaggregated form. Additionally, or alternatively, the aspects may be performed by the UE 802 autonomously, in addition to, and/or in lieu of, operations of the base station 804.

In the illustrated aspect, the base station 804 may be configured to run or execute an ML model for the prediction of beams, e.g., via inference. The base station 804 may be configured to configure the UE 802 with a priority condition 806 associated with the prediction, discussed in further detail below. In some aspects, alternately or in addition, the priority condition 806 associated with the prediction is associated with the UE 802, e.g., by pre-configuration with or without communication from the base station 804, and stored in memory of the UE 802. The base station 804 may also be configured to transmit/provide, for the UE 802 and prior to the generation of the prediction (e.g., for a beam(s)), a reference signal (RS) 808. In aspects, the RS 808 may refer generally to one or more CSI-RSs, SSBs, and/or the like.

The UE 802 may be configured to perform (at 810) at least one measurement for a first set of reference signal metrics of the RS 808. In aspects, the first set of reference signal metrics for which a measurement(s) is performed (at 810) by the UE 802 may be and/or have a type of SINR, RSRP, etc., and may be referred to as measured/past reference signal metrics. The first set of reference signal metrics may include one or more values measured for the RS 808 at different times, the same time, etc.

The base station 804 may be configured to receive, from the UE 802, a measurement indication 812 of at least one measurement for a first set of reference signal metrics of the RS 808. The first set of reference signal metrics of the RS 808 indicated by the measurement indication 812 may be associated with the priority condition 806 associated with the prediction of beams. The measurement indication 812 may be received as CSI, in aspects. The base station 804 may be configured to generate (at 814), based on the ML model, the priority condition 806 associated with the prediction, and/or the measurement indication 812 of the at least one measurement for the first set of reference signal metrics of the RS 808, the prediction for a second set of reference signal metrics of the RS 808. As an example, the at least one measurement for a first set of reference signal metrics of the RS 808 indicated in the measurement indication 812 may be an input for the ML model executed at the base station 804, and the prediction for the second set of reference signal metrics of the RS 808 that is generated (at 814) may be an output of the ML model. In aspects, the prediction for the second set of reference signal metrics of the RS 808 may correspond to a future time and/or future communications with the UE 802.

The base station 804 may be configured to transmit/provide, and the UE 802 may be configured to receive, an indication 816 of the prediction that is generated (at 814) by the base station 804. The predicted metric(s) (e.g., the second set of reference signal metrics of the RS 808) may be reported by the base station 804 to the UE 802, as a portion of the indication 816 of the prediction via DL signaling. The indication 816 of the prediction for the second set of reference signal metrics of the RS 808 may be associated with at least one beam, in various aspects. The base station 804 and the UE 802 may be configured to communicate (at 818) at a future time via the at least one beam based on the indication 816 of the prediction. That is, a beam(s) associated with the indication 816 of the prediction that is transmitted/provided by the base station 804 and received by the UE 802 may be later utilized for the base station 804 and/or the UE 802 to communicate (at 818).

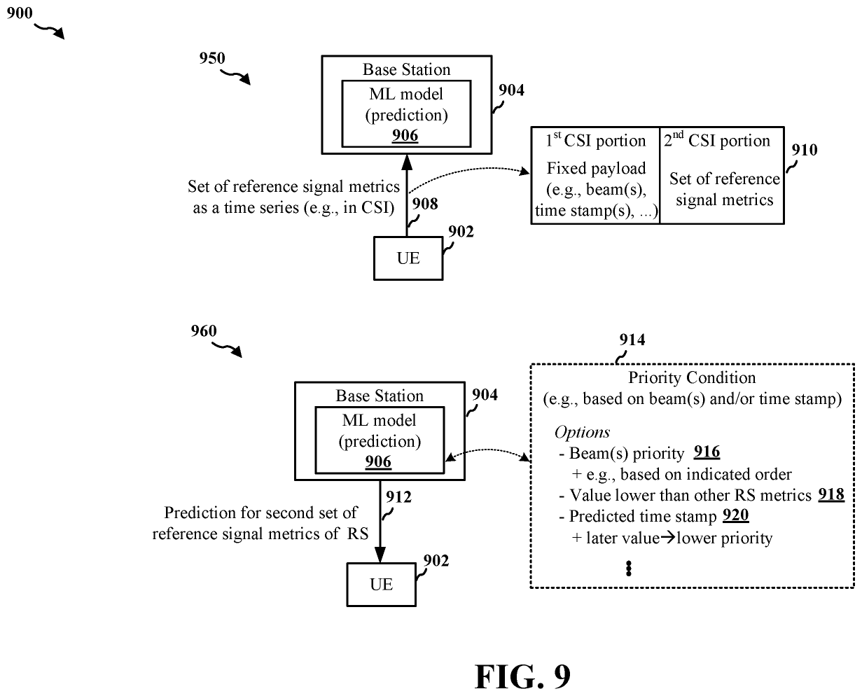

FIG. 9 is a diagram 900 illustrating examples of measurement indications and priority conditions, in various aspects. Diagram 900 shows a configuration 950 and a configuration 960 in the context of a base station 904 and a UE 902. Diagram 900 may be an aspect of call flow diagram 800 in FIG. 8, and the base station 904 and the UE 902 may be respective aspects of the base station 804 and the UE 802 in FIG. 8.

In the configuration 950, described also in the context of FIG. 8, the base station 904 is shown as including an ML model 906, which may be utilized for inference/prediction of beams, as described herein. As noted above in the description of FIG. 8, measured metric(s) (e.g., the first set of reference signal metrics of the RS 808) may be reported to the base station 804, as a portion of the measurement indication 812 by the UE 802, as CSI. In the configuration 950, a measured metric(s) (e.g., the first set of reference signal metrics of the RS 808) may be reported by the UE 902, as a time series of the reference signal metrics of the RS 808 and/or as a portion of a measurement indication 908, to the base station 904, as CSI 910. That is, the base station 904 may be configured to receive the measurement indication 908 of the at least one measurement for the first set of reference signal metrics of the RS 808 as the CSI 910 that is associated with the at least one measurement (e.g., performed at 810) for the first set of reference signal metrics of the RS 808. In aspects, the CSI 910 may include a first portion and a second portion. In such aspects, the first portion may include a fixed payload indicative of at least one beam and/or a time stamp(s) associated therewith, and the second portion may include the first set of reference signal metrics of the RS 808. The measurement indication 908 may be utilized by the base station 904 as an input to the ML model 906 for beam prediction, where in a reported time series of reference signal metrics, e.g., RSRPs, reference signal metrics may correspond to different time stamps/beams and may have different priorities.

Referring now to the configuration 960, described also in the context of FIG. 8, an aspect for a priority condition 914 is shown. In the illustrated aspect, the priority condition 914 may be implemented by the base station 904 for providing an indication 912 of the prediction generated (e.g., at 814 in FIG. 8) by the base station 904. As noted above in the description of FIG. 8, predicted metric(s) (e.g., the second set of reference signal metrics of the RS 808) may be transmitted/provided by the base station 804, as a portion of the indication 816 of the prediction, to the UE 802. In the configuration 960, a predicted metric(s) (e.g., the second set of reference signal metrics of the RS 808) may be transmitted/provided by the base station 904, as a portion of the indication 912 of the prediction, to the UE 902, via DL signaling based on a priority condition 914.

In aspects, the indication 912 of the prediction for the second set of reference signal metrics of the RS 808 may be associated with at least one beam, and one or more beams of the at least one beam may be indicated in the indication 912 of the prediction as having a high priority in a beam priority 916 based on indicia thereof in the priority condition 914. In such aspects, the high priority of the one or more beams may be based on an order of the one or more beams within the indication 912 of the prediction. As one example, a highest value for the beam priority 916 indicated in the priority condition 914 may correspond to a given beam being listed first in the indication 912 of the prediction, while a lowest value for the beam priority 916 indicated in the priority condition 914 may correspond to a given beam being listed last in the indication 912 of the prediction. In another example, the first set of reference signal metrics of the RS 808 may be associated with a lower priority (e.g., a value 918 that is lower) than any other set of reference signal metrics of any other reference signal associated with the base station 904 and the UE 902. In one example, the priority condition 914 associated with the prediction may be based on a predicted time stamp 920 that corresponds to the second set of reference signal metrics, where later values of the predicted time stamp 920 are associated with lower relative priorities compared to earlier values of the predicted time stamp 920. In another example, the priority condition 914 may be based on a reference signal metric type (e.g., as described above for FIG. 7 (730)) associated with the predicted metrics (e.g., associated with the first set of reference signal metrics and/or the second set of reference signal metrics, described herein). In such aspects, the reference signal metric type may be an RSRP, a signal-to-interference and noise ratio (SINR), and/or the like, where an RSRP type is given a higher priority than an SINR type or another interference type.

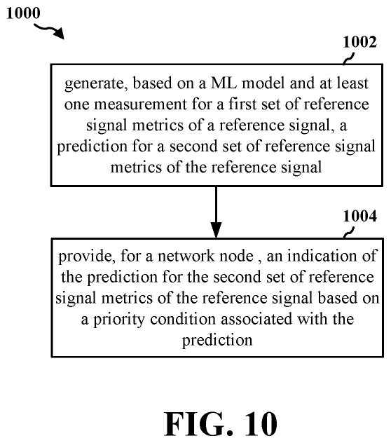

FIG. 10 is a flowchart 1000 of a method of wireless communication, in various aspects. The method may be performed by a UE (e.g., the UE 104, 602, 702, 802, 902; the apparatus 1204). In some aspects, the method may include aspects described in connection with the communication flow in FIG. 6 and/or aspects described in FIGS. 7, 8, 9. The method may be for prediction based UCI multiplexing priority provide multiplexing and priority conditions by which measured and predicted reference signal metrics are indicated to network nodes and UEs to support accurate and efficient beam predictions/inferences.

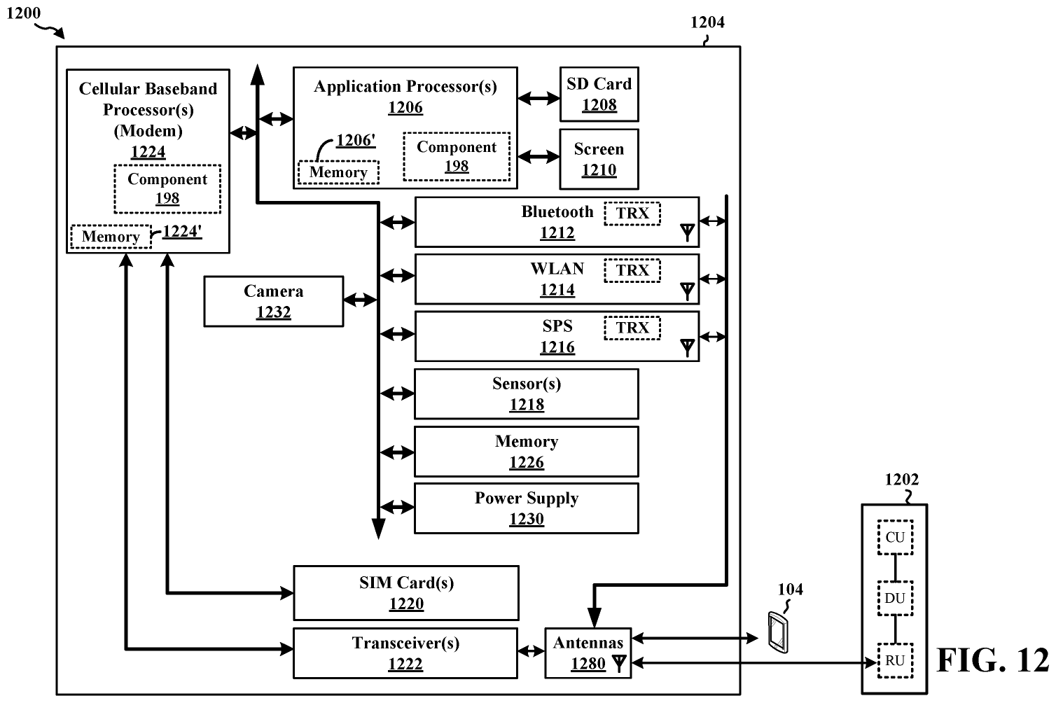

In 1002, the UE generates, based on an ML model and at least one measurement for a first set of reference signal metrics of a reference signal, a prediction for a second set of reference signal metrics of the reference signal. As an example, the generation may be performed by one or more of the component 198, the transceiver 1222, and/or the antenna 1280 in FIG. 12. FIGS. 6, 7 illustrate an example of the UE 602 generating such a prediction associated with a reference signal from a network node (e.g., the base station 604).

In the illustrated aspect of FIG. 6, the UE 602 may be configured to run or execute an ML model (e.g., 706 in FIG. 7) for the prediction of beams, e.g., via inference. The UE 602 may be configured to receive, and the base station 604 may be configured to transmit/provide, a ML configuration 606 that is indicative of the ML model (also ML module/function) (e.g., 706 in FIG. 7) to be executed by the UE 602. In aspects, different ML models (e.g., 706 in FIG. 7) may be configured for the UE 602 by the ML configuration 606, e.g., for different metric types such as SINR, RSRP, etc., for different beams and/or cells, for different prediction time ranges/time stamps (e.g., 722 in FIG. 7) such a next slot, a next 10 slot average, etc. Different prediction modules/outputs of the ML configuration 606 may have different confidence levels (e.g., 732 in FIG. 7), which may be indicated by a value of the previous average errors. The ML configuration 606 and the indicated ML model (e.g., 706 in FIG. 7) may also be associated with a priority condition(s) (e.g., 710, 720 in FIG. 7) that may be indicative of/a basis for how multiplexing and reporting is performed for the above-mentioned parameters and by which the UE 602 determines reference signal metric predictions/measurements to be provided for the base station 604. The UE 602 may also be configured to receive, from the base station 604 and prior to the generation (at 612) of the prediction (e.g., for a beam(s)), a reference signal (RS) 608. In aspects, the RS 608 may refer generally to one or more CSI-RSs, SSBs, and/or the like. The UE 602 may be configured to perform (at 610) at least one measurement for a first set of reference signal metrics of the RS 608. In aspects, the first set of reference signal metrics for which a measurement(s) is performed (at 610) by the UE 602 may be and/or have a type of SINR, RSRP, etc. (e.g., 730 in FIG. 7), and may be referred to as measured/past reference signal metrics. The first set of reference signal metrics may include one or more values measured for the RS 608 at different times, the same time, etc. (e.g., 722 in FIG. 7). The UE 602 may be configured to generate (at 612), based on the ML model (e.g., 706 in FIG. 7) (e.g., as indicated in the ML configuration 606) and the at least one measurement for a first set of reference signal metrics of the RS 608 (e.g., as performed at 610), a prediction for a second set of reference signal metrics of the RS 608. As an example, the at least one measurement for a first set of reference signal metrics of the RS 608 may be an input for the ML model (e.g., 706 in FIG. 7) executed at the UE 602, and the prediction for the second set of reference signal metrics of the RS 608 that is generated (at 610) may be an output of the ML model (e.g., 706 in FIG. 7). In aspects, the prediction for the second set of reference signal metrics of the RS 608 may correspond to a future time and/or future communications with the base station 604.

In 1004, the UE provides, for a network node, an indication of the prediction for the second set of reference signal metrics of the reference signal based on a priority condition associated with the prediction. As an example, the provision may be performed by one or more of the component 198, the transceiver 1222, and/or the antenna 1280 in FIG. 12. FIGS. 6, 7 illustrate an example of the UE 602 providing such an indication of a prediction to a network node (e.g., the base station 604).

The UE 602 may be configured to transmit/provide, and the base station 604 may be configured to receive, an indication 614 of the prediction (e.g., 708 in FIG. 7) that is generated (at 612) by the UE 602. The predicted metric(s) (e.g., the second set of reference signal metrics of the RS 608) may be reported by the UE 602, as a portion of the indication 614 of the prediction (e.g., 708 in FIG. 7), to the base station 604 via UCI. The indication 614 of the prediction (e.g., 708 in FIG. 7) for the second set of reference signal metrics of the RS 608 may be associated with at least one beam, in various aspects. The UE 602 and the base station 604 may be configured to communicate (at 616) at a future time via the at least one beam based on the indication 614 of the prediction (e.g., 708 in FIG. 7). That is, a beam(s) associated with the indication 614 of the prediction (e.g., 708 in FIG. 7) that is transmitted/provided by the UE 602 and received by the base station 604 may be later utilized for the UE 602 and/or the base station 604 to communicate (at 616).

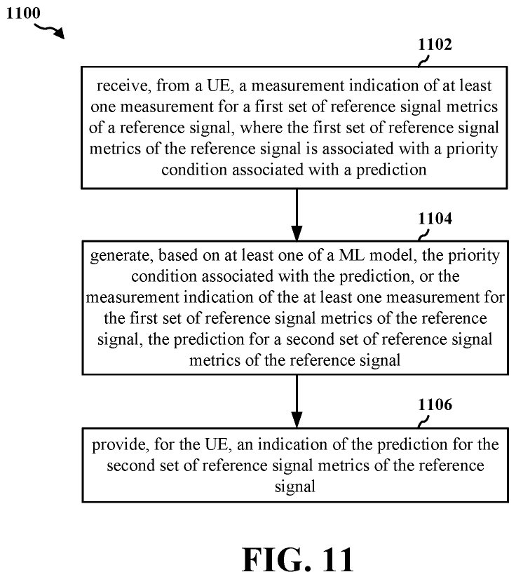

FIG. 11 is a flowchart 1100 of a method of wireless communication, in various aspects. The method may be performed by a network node (e.g., the base station 102, 604, 704, 804, 904; the network entity 1202, 1302). In some aspects, the method may include aspects described in connection with the communication flow in FIG. 8 and/or aspects described in FIGS. 6, 7, 9. The method may be for prediction based UCI multiplexing priority provide multiplexing and priority conditions by which measured and predicted reference signal metrics are indicated to network nodes and UEs to support accurate and efficient beam predictions/inferences.

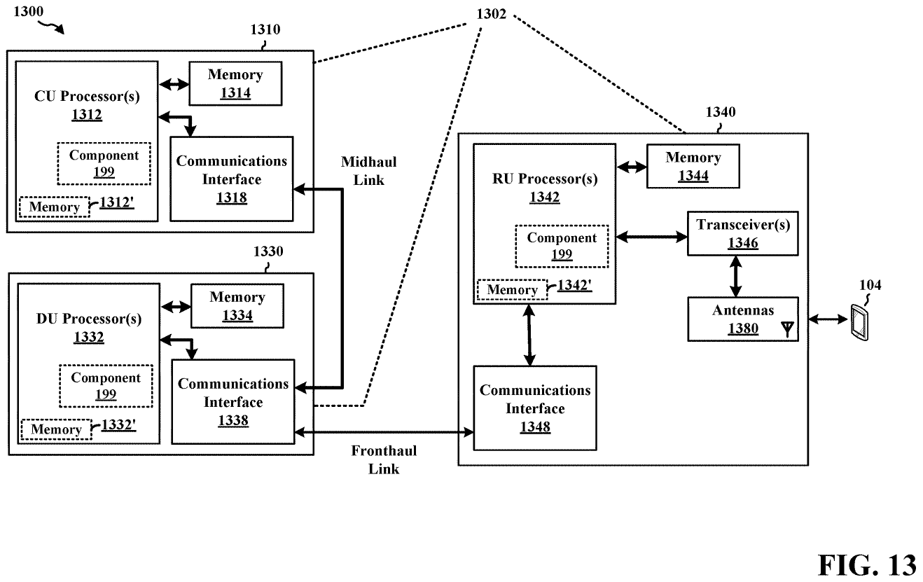

In 1102, the network node receives, from a UE, a measurement indication of at least one measurement for a first set of reference signal metrics of a reference signal, where the first set of reference signal metrics of the reference signal is associated with a priority condition associated with a prediction. As an example, the reception may be performed by one or more of the component 199, the transceiver 1346, and/or the antenna 1380 in FIG. 13. FIGS. 8, 9 illustrate an example of the network node (e.g., the base station 804) receiving such a measurement indication from a UE (e.g., the UE 802).

In the illustrated aspect of FIG. 8, the base station 804 may be configured to run or execute an ML model (e.g., 906 in FIG. 9) for the prediction (e.g., 912 in FIG. 9) of beams, e.g., via inference. The base station 804 may be configured to configure the UE 802 with a priority condition 806 (e.g., 914 in FIG. 9) associated with the prediction (e.g., 912 in FIG. 9), discussed in further detail below. In some aspects, alternately or in addition, the priority condition 806 (e.g., 914 in FIG. 9) associated with the prediction (e.g., 912 in FIG. 9) is associated with the UE 802, e.g., by pre-configuration with or without communication from the base station 804, and stored in memory of the UE 802. The base station 804 may also be configured to transmit/provide, for the UE 802 and prior to the generation of the prediction (e.g., 912 in FIG. 9) (e.g., for a beam(s)), a reference signal (RS) 808. In aspects, the RS 808 may refer generally to one or more CSI-RSs, SSBs, and/or the like. The UE 802 may be configured to perform (at 810) at least one measurement for a first set of reference signal metrics of the RS 808. In aspects, the first set of reference signal metrics for which a measurement(s) is performed (at 810) by the UE 802 may be and/or have a type of SINR. RSRP, etc., and may be referred to as measured/past reference signal metrics. The first set of reference signal metrics may include one or more values measured for the RS 808 at different times, the same time, etc. The base station 804 may be configured to receive, from the UE 802, a measurement indication 812 (e.g., 908 in FIG. 9) of at least one measurement for a first set of reference signal metrics of the RS 808. The first set of reference signal metrics of the RS 808 indicated by the measurement indication 812 (e.g., 908 in FIG. 9) may be associated with the priority condition 806 (e.g., 914 in FIG. 9) associated with the prediction (e.g., 912 in FIG. 9) of beams. The measurement indication 812 may be received as CSI (e.g., 910), in aspects.

In 1104, the network node generates, based on at least one of an ML model, the priority condition associated with the prediction, or the measurement indication of the at least one measurement for the first set of reference signal metrics of the reference signal, the prediction for a second set of reference signal metrics of the reference signal. As an example, the generation may be performed by one or more of the component 199, the transceiver 1346, and/or the antenna 1380 in FIG. 13. FIGS. 8, 9 illustrate an example of the network node (e.g., the base station 804) generating such a prediction associated with reference signal metrics from a UE (e.g., the UE 802).

The base station 804 may be configured to generate (at 814), based on the ML model (e.g., 906 in FIG. 9), the priority condition 806 (e.g., 914 in FIG. 9) associated with the prediction (e.g., 912 in FIG. 9), and/or the measurement indication 812 (e.g., 908 in FIG. 9) of the at least one measurement for the first set of reference signal metrics of the RS 808, the prediction (e.g., 912 in FIG. 9) for a second set of reference signal metrics of the RS 808. As an example, the at least one measurement for a first set of reference signal metrics of the RS 808 indicated in the measurement indication 812 (e.g., 908 in FIG. 9) may be an input for the ML model (e.g., 906 in FIG. 9) executed at the base station 804, and the prediction (e.g., 912 in FIG. 9) for the second set of reference signal metrics of the RS 808 that is generated (at 814) may be an output of the ML model (e.g., 906 in FIG. 9). In aspects, the prediction (e.g., 912 in FIG. 9) for the second set of reference signal metrics of the RS 808 may correspond to a future time and/or future communications with the UE 802.

In 1106, the network node provides, for the UE, an indication of the prediction for the second set of reference signal metrics of the reference signal. As an example, the provision may be performed by one or more of the component 199, the transceiver 1346, and/or the antenna 1380 in FIG. 13. FIGS. 8, 9 illustrate an example of the network node (e.g., the base station 804) providing such an indication of a prediction to a UE (e.g., the UE 802).

The base station 804 may be configured to transmit/provide, and the UE 802 may be configured to receive, an indication 816 of the prediction (e.g., 912 in FIG. 9) that is generated (at 814) by the base station 804. The predicted metric(s) (e.g., the second set of reference signal metrics of the RS 808) may be reported by the base station 804 to the UE 802, as a portion of the indication 816 of the prediction (e.g., 912 in FIG. 9) via DL signaling. The indication 816 of the prediction (e.g., 912 in FIG. 9) for the second set of reference signal metrics of the RS 808 may be associated with at least one beam, in various aspects. The base station 804 and the UE 802 may be configured to communicate (at 818) at a future time via the at least one beam based on the indication 816 of the prediction (e.g., 912 in FIG. 9). That is, a beam(s) associated with the indication 816 of the prediction (e.g., 912 in FIG. 9) that is transmitted/provided by the base station 804 and received by the UE 802 may be later utilized for the base station 804 and/or the UE 802 to communicate (at 818).

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor(s) 1224 communicates through the transceiver(s) 1222 via one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The cellular baseband processor(s) 1224 and the application processor(s) 1206 are configured to perform the various functions described supra based at least in part of the information stored in the memory. That is, the cellular baseband processor(s) 1224 and the application processor(s) 1206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the component 198 may be configured to generate, based on an ML model and at least one measurement for a first set of reference signal metrics of a reference signal, a prediction for a second set of reference signal metrics of the reference signal. The component 198 may also be configured to provide, for a network node, an indication of the prediction for the second set of reference signal metrics of the reference signal based on a priority condition associated with the prediction. The component 198 may be configured to communicate via at least one beam based on the indication of the prediction, where the indication of the prediction for the second set of reference signal metrics of the reference signal is associated with the at least one beam. The component 198 may be configured to receive, from the network node, an ML configuration indicative of the ML model. The component 198 may be configured to receive, from the network node and prior to the generation of the prediction, the reference signal. The component 198 may be configured to perform the at least one measurement for the first set of reference signal metrics of the reference signal. The component 198 may be further configured to perform any of the aspects described in connection with the flowcharts in any of FIGS. 10, 11 and/or any of the aspects performed by a UE for any of FIGS. 6-9. The component 198 may be within the cellular baseband processor(s) 1224, the application processor(s) 1206, or both the cellular baseband processor(s) 1224 and the application processor(s) 1206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for generating, based on an ML model and at least one measurement for a first set of reference signal metrics of a reference signal, a prediction for a second set of reference signal metrics of the reference signal. In the configuration, the apparatus 1204, and in particular the cellular baseband processor(s) 1224 and/or the application processor(s) 1206, may include means for providing, for a network node, an indication of the prediction for the second set of reference signal metrics of the reference signal based on a priority condition associated with the prediction. In one configuration, the apparatus 1204, and in particular the cellular baseband processor(s) 1224 and/or the application processor(s) 1206, may include means for communicating via at least one beam based on the indication of the prediction, where the indication of the prediction for the second set of reference signal metrics of the reference signal is associated with the at least one beam. In one configuration, the apparatus 1204, and in particular the cellular baseband processor(s) 1224 and/or the application processor(s) 1206, may include means for receiving, from the network node, an ML configuration indicative of the ML model. In one configuration, the apparatus 1204, and in particular the cellular baseband processor(s) 1224 and/or the application processor(s) 1206, may include means for receiving, from the network node and prior to the generation of the prediction, the reference signal. In one configuration, the apparatus 1204, and in particular the cellular baseband processor(s) 1224 and/or the application processor(s) 1206, may include means for performing the at least one measurement for the first set of reference signal metrics of the reference signal. The means may be the component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′. 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to receive, from a UE, a measurement indication of at least one measurement for a first set of reference signal metrics of a reference signal, where the first set of reference signal metrics of the reference signal is associated with a priority condition associated with a prediction. The component 199 may also be configured to generate, based on at least one of an ML model, the priority condition associated with the prediction, or the measurement indication of the at least one measurement for the first set of reference signal metrics of the reference signal, the prediction for a second set of reference signal metrics of the reference signal. The component 199 may also be configured to provide, for the UE, an indication of the prediction for the second set of reference signal metrics of the reference signal. The component 199 may be configured to communicate via at least one beam based on at least one of the prediction or the indication of the prediction, where the indication of the prediction for the second set of reference signal metrics of the reference signal is associated with the at least one beam. The component 199 may be configured to configure the UE with the priority condition associated with the prediction. The component 199 may be configured to provide, to the UE and prior to the generation of the prediction, the reference signal. The component 199 may be further configured to perform any of the aspects described in connection with the flowcharts in any of FIGS. 10, 11 and/or any of the aspects performed by a network node/base station for any of FIGS. 6-9. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for receiving, from a UE, a measurement indication of at least one measurement for a first set of reference signal metrics of a reference signal, where the first set of reference signal metrics of the reference signal is associated with a priority condition associated with a prediction. In the configuration, the network entity 1302 may include means for generating, based on at least one of an ML model, the priority condition associated with the prediction, or the measurement indication of the at least one measurement for the first set of reference signal metrics of the reference signal, the prediction for a second set of reference signal metrics of the reference signal. In the configuration, the network entity 1302 may include means for providing, for the UE, an indication of the prediction for the second set of reference signal metrics of the reference signal. In one configuration, the network entity 1302 may include means for communicating via at least one beam based on at least one of the prediction or the indication of the prediction, where the indication of the prediction for the second set of reference signal metrics of the reference signal is associated with the at least one beam. In one configuration, the network entity 1302 may include means for configuring the UE with the priority condition associated with the prediction. In one configuration, the network entity 1302 may include means for providing, to the UE and prior to the generation of the prediction, the reference signal. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communication networks that support communications between network nodes and UEs may utilize beam forming and management to improve performance through beam prediction in time and/or spatial domains for overhead/latency reduction, as well as improvements in beam selection accuracy. In some cases, AI/ML may be utilized to predict beams, and may involve indications of capabilities, configuration procedures (e.g., training/inference), validation/testing procedures, and management of data and/or AI/ML models. These modes may be NN models with standardized inputs and outputs for each NNF, including inter-vendor IEs and optional IEs for flexible implementations. However, some configurations for UCI reporting and priority conditions may be insufficient for ML based beam prediction procedures. For example, ML based beam predictions may benefit from information such as prediction time, an ML model ID, confidence level, and/or the like, along with associated priorities, which are not provided in current implementations. Additionally, while CSI may be provided to a network node from a UE to indicate RS measurements associated with beam configurations, such reporting may be based on priorities that do not sufficiently account for time series measurements in UE-side ML model implementations. Further, there is a lack of multiplexing priority conditions for UE-side ML modeling.

Aspects herein for prediction based UCI multiplexing priority provide for various types of reports for ML based beam prediction. For instance, in base station implementations for beam prediction, a UE may report a time series of measured RSRPs or RSRP values, while in UE implementations for beam prediction, a UE may report predicted RSRPs or RSRP values. The reports according to aspects herein may be reported to a base station as UCI, and multiplexing conditions/rules may be provided for the described UCI types to support beam prediction. In some examples, CSI report priority conditions based on the nature of prediction related UCI are provided, extending prior reporting to account for prediction time, ML model ID, confidence level, and/or the like. In various aspects, a prediction report that corresponds to later time may be skipped first, different ML models/ML functions may have different priorities, and reports with low confidence/high error level may be skipped first (e.g., low confidence/high error level may be derived based on a history performance monitoring procedure such as when certain prediction functions on average have a lower/higher RSRP prediction error. Beams may be flexibly predicted by a UE or by the network by providing implementations for beam prediction at network nodes and at UEs with varied UE reporting according to the specific implementations. Available bandwidth may be efficiently used by providing multiplexing conditions/rules in reporting for beam prediction. Available bandwidth may also be efficiently used while also utilizing more desirable data as inputs for ML beam prediction models by providing priority conditions/rules in reporting for beam prediction.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X. X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is method of wireless communication at a user equipment (UE), comprising: generating, based on a machine learning (ML) model and at least one measurement for a first set of reference signal metrics of a reference signal, a prediction for a second set of reference signal metrics of the reference signal; and providing, for a network node, an indication of the prediction for the second set of reference signal metrics of the reference signal based on a priority condition associated with the prediction.

Aspect 2 is the method of aspect 1, wherein the indication of the prediction for the second set of reference signal metrics of the reference signal is associated with at least one beam, wherein the method further comprises: communicating, with the network node, via the at least one beam based on the indication of the prediction.

Aspect 3 is the method of any of aspects 1 and 2, wherein providing the indication of the prediction for the second set of reference signal metrics of the reference signal comprises providing the indication of the prediction via uplink control information (UCI) based on the priority condition.

Aspect 4 is the method of aspect 3, wherein the UCI has a first priority that is lower than at least one of a second priority of an acknowledgement (ACK) associated with the UE or a third priority of a scheduling request (SR) associated with the UE.

Aspect 5 is the method of aspect 4, wherein the indication of the prediction for the second set of reference signal metrics of the reference signal comprises channel state information (CSI), wherein the UCI comprises a CSI report.

Aspect 6 is the method of any of aspects 1 to 5, wherein the provision of the indication of the prediction overlaps in time with a provision of a channel state information (CSI) report, and wherein the priority condition is based on a predicted time stamp corresponding to the second set of reference signal metrics, wherein later values of the predicted time stamp are associated with lower relative priorities compared to earlier values of the predicted time stamp.

Aspect 7 is the method of any of aspects 1 to 6, wherein the provision of the indication of the prediction overlaps in time with a provision of a channel state information (CSI) report, and wherein the priority condition is based on whether the prediction is associated with a measurement of the second set of reference signal metrics.

Aspect 8 is the method of any of aspects 1 to 7, wherein the provision of the indication of the prediction overlaps in time with a provision of a channel state information (CSI) report, and wherein the priority condition is based on a model priority of the ML model.

Aspect 9 is the method of any of aspects 1 to 8, wherein the provision of the indication of the prediction overlaps in time with a provision of a channel state information (CSI) report, and wherein the priority condition is based on whether the prediction is associated with a serving cell measurement or a non-serving cell measurement.

Aspect 10 is the method of any of aspects 1 to 9, wherein the provision of the indication of the prediction overlaps in time with a provision of a channel state information (CSI) report, and wherein the priority condition is based on a reference signal metric type associated with the first set of reference signal metrics and the second set of reference signal metrics.

Aspect 11 is the method of aspect 10, wherein the reference signal metric type is at least one of a reference signal received power (RSRP) or a signal-to-interference and noise ratio (SINR).

Aspect 12 is the method of any of aspects 1 to 11, wherein provision of the indication of the prediction overlaps in time with a provision of a channel state information (CSI) report, and wherein the priority condition is based on a confidence level or an expected average error associated with the prediction.

Aspect 13 is the method of any of aspects 1 to 12, further comprising: receiving, from the network node, a machine learning (ML) configuration indicative of the ML model.

Aspect 14 is the method of any of aspects 1 to 13, further comprising: receiving, from the network node and prior to the generation of the prediction, the reference signal; and performing the at least one measurement for the first set of reference signal metrics of the reference signal.

Aspect 15 is a method of wireless communication at a network node, comprising: receiving, from a user equipment (UE), a measurement indication of at least one measurement for a first set of reference signal metrics of a reference signal, wherein the first set of reference signal metrics of the reference signal is associated with a priority condition associated with a prediction; generating, based on at least one of a machine learning (ML) model, the priority condition associated with the prediction, or the measurement indication of the at least one measurement for the first set of reference signal metrics of the reference signal, the prediction for a second set of reference signal metrics of the reference signal; and providing, for the UE, an indication of the prediction for the second set of reference signal metrics of the reference signal.

Aspect 16 is the method of aspect 15, wherein the indication of the prediction for the second set of reference signal metrics of the reference signal is associated with at least one beam, wherein the method further comprises: communicating, with the UE, via the at least one beam based on at least one of the prediction or the indication of the prediction.

Aspect 17 is the method of aspect 16, wherein the first set of reference signal metrics is a time series of the reference signal metrics of the reference signal, wherein receiving the measurement indication of the at least one measurement for the first set of reference signal metrics of the reference signal comprises receiving channel state information (CSI) associated with the at least one measurement for the first set of reference signal metrics of the reference signal.

Aspect 18 is the method of aspect 17, wherein the CSI includes a first portion and a second portion, wherein the first portion includes a fixed payload indicative of one or more of at least one beam or a time stamp associated therewith, wherein the second portion includes the first set of reference signal metrics.

Aspect 19 is the method of any of aspects 15 to 18, wherein at least one reference signal metric of the first set of reference signal metrics is associated with a respective priority, according to the priority condition, based on one or more of at least one beam or a time stamp associated therewith; wherein generating the prediction for the second set of reference signal metrics of the reference signal comprises generating the prediction based on at least one of the respective priority associated with the at least one reference signal metric.

Aspect 20 is the method of aspect 19, wherein the indication of the prediction for the second set of reference signal metrics of the reference signal is associated with the at least one beam, wherein one or more beams of the at least one beam are indicated in the indication of the prediction as having a high priority.

Aspect 21 is the method of aspect 20, wherein the high priority of the one or more beams is based on an order of the one or more beams within the indication of the prediction.

Aspect 22 is the method of aspect 19, wherein the first set of reference signal metrics of the reference signal is associated with a lower priority than any other set of reference signal metrics of any other reference signal associated with the network node and the UE.

Aspect 23 is the method of aspect 19, wherein the priority condition associated with the prediction is based on a predicted time stamp corresponding to the second set of reference signal metrics, wherein later values of the predicted time stamp are associated with lower relative priorities compared to earlier values of the predicted time stamp.

Aspect 24 is the method of aspect 19, further comprising configuring the UE with the priority condition associated with the prediction; or wherein the priority condition associated with the prediction is associated with the UE.

Aspect 25 is the method of any of aspects 15 to 24, wherein the priority condition is based on a reference signal metric type associated with the first set of reference signal metrics and the second set of reference signal metrics, wherein the reference signal metric type is at least one of a reference signal received power (RSRP) or a signal-to-interference and noise ratio (SINR).

Aspect 26 is the method of any of aspects 15 to 25, further comprising: providing, to the UE and prior to the generation of the prediction, the reference signal.

Aspect 27 is an apparatus for wireless communication at a UE including means for implementing any of aspects 1 to 14.

Aspect 28 is a computer-readable medium (e.g., a non-transitory computer-readable medium) storing computer executable code for wireless communication at a UE, the code when executed by at least one processor causes the UE to implement any of aspects 1 to 14.

Aspect 29 is an apparatus for wireless communication at a user equipment (UE), comprising: at least one memory; and at least one processor coupled to the at least one memory and, based at least in part on information stored in the at least one memory, the at least one processor, individually or in any combination, is configured to cause the UE to perform the method of any of aspects 1 to 14.

Aspect 30 is the apparatus of aspect 29 further including at least one of a transceiver or an antenna coupled to the at least one processor.

Aspect 31 is an apparatus for wireless communication at a network node including means for implementing any of aspects 15 to 26.

Aspect 32 is a computer-readable medium (e.g., a non-transitory computer-readable medium) storing computer executable code for wireless communication at a network node, the code when executed by at least one processor causes the UE to implement any of aspects 15 to 26.

Aspect 33 is an apparatus for wireless communication at a network node, comprising: at least one memory; and at least one processor coupled to the at least one memory and, based at least in part on information stored in the at least one memory, the at least one processor, individually or in any combination, is configured to cause the UE to perform the method of any of aspects 15 to 26.

Aspect 34 is the apparatus of aspect 33 further including at least one of a transceiver or an antenna coupled to the at least one processor.

Aspect 35 is an apparatus for wireless communication at a user equipment (UE), comprising: at least one memory; and at least one processor coupled to the at least one memory and, based at least in part on information stored in the at least one memory, the at least one processor, individually or in any combination, is configured to perform the method of any of aspects 1 to 14.

Aspect 36 is an apparatus for wireless communication at a user equipment (UE), comprising means for performing each step in the method of any of aspects 1 to 14.

Aspect 37 is the apparatus of any of aspects 35 and 36, further comprising a transceiver configured to receive or to transmit in association with the method of any of aspects 1 to 14.

Aspect 38 is a computer-readable medium (e.g., a non-transitory computer-readable medium) storing computer executable code at a user equipment (UE), the code when executed by at least one processor causes the at least one processor to perform the method of any of aspects 1 to 14.

Aspect 39 is an apparatus for wireless communication at a network node, comprising: at least one memory; and at least one processor coupled to the at least one memory and, based at least in part on information stored in the at least one memory, the at least one processor, individually or in any combination, is configured to perform the method of any of aspects 15 to 26.

Aspect 40 is an apparatus for wireless communication at a network node, comprising means for performing each step in the method of any of aspects 15 to 26.

Aspect 41 is the apparatus of any of aspects 39 and 40, further comprising a transceiver configured to receive or to transmit in association with the method of any of aspects 15 to 26.

Aspect 42 is a computer-readable medium storing computer executable code at a network node, the code when executed by at least one processor causes the at least one processor to perform the method of any of aspects 15 to 26.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
generate, based on a machine learning (ML) model and at least one measurement for a first set of reference signal metrics of a reference signal, a prediction for a second set of reference signal metrics of the reference signal; and
provide, for a network node, an indication of the prediction for the second set of reference signal metrics of the reference signal based on a priority condition associated with the prediction.

2. The apparatus of claim 1, wherein the indication of the prediction for the second set of reference signal metrics of the reference signal is associated with at least one beam, wherein the at least one processor, individually or in any combination, is further configured to:
communicate, with the network node, via the at least one beam based on the indication of the prediction.

3. The apparatus of claim 1, wherein to provide the indication of the prediction for the second set of reference signal metrics of the reference signal, the at least one processor, individually or in any combination, is configured to provide the indication of the prediction via uplink control information (UCI) based on the priority condition.

4. The apparatus of claim 3, wherein the UCI has a first priority that is lower than at least one of a second priority of an acknowledgement (ACK) associated with the UE or a third priority of a scheduling request (SR) associated with the UE.

5. The apparatus of claim 4, wherein the indication of the prediction for the second set of reference signal metrics of the reference signal comprises channel state information (CSI), wherein the UCI comprises a CSI report.

6. The apparatus of claim 1, wherein the provision of the indication of the prediction overlaps in time with a provision of a channel state information (CSI) report, and wherein the priority condition is based on a predicted time stamp corresponding to the second set of reference signal metrics, wherein later values of the predicted time stamp are associated with lower relative priorities compared to earlier values of the predicted time stamp.

7. The apparatus of claim 1, wherein the provision of the indication of the prediction overlaps in time with a provision of a channel state information (CSI) report, and wherein the priority condition is based on whether the prediction is associated with a measurement of the second set of reference signal metrics.

8. The apparatus of claim 1, wherein the provision of the indication of the prediction overlaps in time with a provision of a channel state information (CSI) report, and wherein the priority condition is based on a model priority of the ML model.

9. The apparatus of claim 1, wherein the provision of the indication of the prediction overlaps in time with a provision of a channel state information (CSI) report, and wherein the priority condition is based on whether the prediction is associated with a serving cell measurement or a non-serving cell measurement.

10. The apparatus of claim 1, wherein the provision of the indication of the prediction overlaps in time with a provision of a channel state information (CSI) report, and wherein the priority condition is based on a reference signal metric type associated with the first set of reference signal metrics and the second set of reference signal metrics.

11. The apparatus of claim 10, wherein the reference signal metric type is at least one of a reference signal received power (RSRP) or a signal-to-interference and noise ratio (SINR).

12. The apparatus of claim 1, wherein provision of the indication of the prediction overlaps in time with a provision of a channel state information (CSI) report, and wherein the priority condition is based on a confidence level or an expected average error associated with the prediction.

13. The apparatus of claim 1, further comprising at least one transceiver coupled to the at least one processor, wherein the at least one processor, individually or in any combination, is further configured to:
receive, from the network node, a machine learning (ML) configuration indicative of the ML model via the at least one transceiver.

14. The apparatus of claim 1, wherein the at least one processor, individually or in any combination, is further configured to:
receive, from the network node and prior to the generation of the prediction, the reference signal; and
perform the at least one measurement for the first set of reference signal metrics of the reference signal.

15. An apparatus for wireless communication at a network node, comprising:
at least one memory; and
at least one processor coupled to the at least one memory and, based at least in part on information stored in the at least one memory, the at least one processor, individually or in any combination, is configured to:
receive, from a user equipment (UE), a measurement indication of at least one measurement for a first set of reference signal metrics of a reference signal, wherein the first set of reference signal metrics of the reference signal is associated with a priority condition associated with a prediction;
generate, based on at least one of a machine learning (ML) model, the priority condition associated with the prediction, or the measurement indication of the at least one measurement for the first set of reference signal metrics of the reference signal, the prediction for a second set of reference signal metrics of the reference signal; and
provide, for the UE, an indication of the prediction for the second set of reference signal metrics of the reference signal.

16. The apparatus of claim 15, wherein the indication of the prediction for the second set of reference signal metrics of the reference signal is associated with at least one beam, wherein the at least one processor, individually or in any combination, is further configured to:
communicate, with the UE, via the at least one beam based on at least one of the prediction or the indication of the prediction.

17. The apparatus of claim 15, wherein the first set of reference signal metrics is a time series of the reference signal metrics of the reference signal, wherein to receive the measurement indication of the at least one measurement for the first set of reference signal metrics of the reference signal, the at least one processor, individually or in any combination, is configured to receive channel state information (CSI) associated with the at least one measurement for the first set of reference signal metrics of the reference signal.

18. The apparatus of claim 17, wherein the CSI includes a first portion and a second portion, wherein the first portion includes a fixed payload indicative of one or more of at least one beam or a time stamp associated therewith, wherein the second portion includes the first set of reference signal metrics.

19. The apparatus of claim 15, wherein at least one reference signal metric of the first set of reference signal metrics is associated with a respective priority, according to the priority condition, based on one or more of at least one beam or a time stamp associated therewith;
wherein to generate the prediction for the second set of reference signal metrics of the reference signal, the at least one processor, individually or in any combination, is configured to generate the prediction based on at least one of the respective priority associated with the at least one reference signal metric.

20. The apparatus of claim 19, wherein the indication of the prediction for the second set of reference signal metrics of the reference signal is associated with the at least one beam, wherein one or more beams of the at least one beam are indicated in the indication of the prediction as having a high priority.

21. The apparatus of claim 20, wherein the high priority of the one or more beams is based on an order of the one or more beams within the indication of the prediction.

22. The apparatus of claim 19, wherein the first set of reference signal metrics of the reference signal is associated with a lower priority than any other set of reference signal metrics of any other reference signal associated with the network node and the UE.

23. The apparatus of claim 19, wherein the priority condition associated with the prediction is based on a predicted time stamp corresponding to the second set of reference signal metrics, wherein later values of the predicted time stamp are associated with lower relative priorities compared to earlier values of the predicted time stamp.

24. The apparatus of claim 19, wherein the at least one processor, individually or in any combination, is further configured to configure the UE with the priority condition associated with the prediction; or
wherein the priority condition associated with the prediction is associated with the UE.

25. The apparatus of claim 15, wherein the priority condition is based on a reference signal metric type associated with the first set of reference signal metrics and the second set of reference signal metrics, wherein the reference signal metric type is at least one of a reference signal received power (RSRP) or a signal-to-interference and noise ratio (SINR).

26. The apparatus of claim 15, further comprising at least one transceiver coupled to the at least one processor, wherein the at least one processor, individually or in any combination, is further configured to:
provide, to the UE and prior to the generation of the prediction, the reference signal.

27. A method of wireless communication at a user equipment (UE), comprising:
generating, based on a machine learning (ML) model and at least one measurement for a first set of reference signal metrics of a reference signal, a prediction for a second set of reference signal metrics of the reference signal; and
providing, for a network node, an indication of the prediction for the second set of reference signal metrics of the reference signal based on a priority condition associated with the prediction.

28. The method of claim 27, wherein the indication of the prediction for the second set of reference signal metrics of the reference signal is associated with at least one beam, wherein the method further comprises:
communicating, with the network node, via the at least one beam based on the indication of the prediction.

29. A method of wireless communication at a network node, comprising:
receiving, from a user equipment (UE), a measurement indication of at least one measurement for a first set of reference signal metrics of a reference signal, wherein the first set of reference signal metrics of the reference signal is associated with a priority condition associated with a prediction;
generating, based on at least one of a machine learning (ML) model, the priority condition associated with the prediction, or the measurement indication of the at least one measurement for the first set of reference signal metrics of the reference signal, the prediction for a second set of reference signal metrics of the reference signal; and
providing, for the UE, an indication of the prediction for the second set of reference signal metrics of the reference signal.

30. The method of claim 29, wherein the indication of the prediction for the second set of reference signal metrics of the reference signal is associated with at least one beam, wherein the method further comprises:
communicating, with the UE, via the at least one beam based on at least one of the prediction or the indication of the prediction.
